(19) United States
(12) Patent Application Publication
(10) Pub. No.: US 2009/0211654 A1
(43) Pub. Date: Aug. 27, 2009

(54) Assembly For The Differential Delivery Of Treated And Mains Water

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 11/994,318

(22) PCT Filed: Jun. 28, 2006
(86) PCT No.: PCT/IB2006/001873

§ 371 Date: Sep. 22, 2008

(30) Foreign Application Priority Data
Jul. 1, 2005 (IT) MI2005A001252

(51) Int. Cl. F16K 11/00; F16L 11/00

(52) U.S. Cl. 137/597; 138/118

(57) ABSTRACT

An assembly for the differential delivery of treated and mains water, comprising a flexible hose for the separate conveyance of treated water and mains water for connection between a spray head provided with at least two separate delivery points and a distribution unit for the separate supply of treated water and mains water. The flexible hose has, at its ends, respectively a first connection port, for connection to the distribution unit, the second port being connectable to the distribution unit so as to allow free rotation about the axis of the second port.

### TECHNICAL FIELD

The present invention relates to an assembly for the differential delivery of treated and mains water.

### BACKGROUND ART

As is known, in many situations mains water may not be fully within the required potability limits, and therefore it is necessary to deliver also water that has been treated by means of filtering devices of different kinds.

The most innovative solutions already use a delivery spray head which allows to have, on a single element, a region for delivering mains water and a region for delivering treated water, which are separated one another.

Currently there are considerable difficulties in providing the connection to the spray head for delivering mains water and treated water, since it is not always easy to provide a connection which does not cause difficulties in the traditional use of water.

A prior solution by the same Applicant already provides a flexible hose which defines, in a single element, two separate ducts, i.e., one for delivering mains water and one for delivering treated water; this solution has proved to be valid in many respects but has been found to be susceptible of improvements especially as regards the devices for connection to the delivery spray head and to the water distribution assembly.

### DISCLOSURE OF THE INVENTION

The aim of the present invention is to solve the problem described above by providing an assembly for the differential delivery of treated and mains water that allows to perform the connection with simple and quick couplings that can provide an optimum seal.

Within this aim, an object of the invention is to provide an assembly equipped with a flexible hose in which it is possible to provide the suitable couplings while keeping strictly separated the delivery of treated water and of mains water.

Another object of the present invention is to provide an assembly for the differential delivery of treated and mains water which, thanks to its particular characteristics, is capable of giving the greatest assurances of reliability and safety in use.

Still another object of the present invention is to provide an assembly that can be obtained easily starting from commonly commercially available elements and materials and is further competitive from a merely economical standpoint.

This aim and these and other objects, which will become better apparent hereinafter, are achieved by an assembly for the differential delivery of treated and mains water, according to the invention, comprising a flexible hose for the separate conveyance of treated water and mains water for connection between a spray head provided with at least two separate delivery points and a distribution unit for the separate supply of treated water and mains water, said flexible hose having, at its ends, respectively a first connection port, for connection to said spray head, and a second connection port, for connection to said distribution unit, characterized in that said second port can be connected to said distribution unit so as to allow free rotation substantially about the axis of said second port.

### BRIEF DESCRIPTION OF THE DRAWINGS

Further characteristics and advantages will become better apparent from the description of a preferred but not exclusive embodiment of an assembly for the differential delivery of treated and mains water, illustrated by way of non-limiting example in the accompanying drawings, wherein:

FIG. 1 is a schematic view of the assembly according to the invention, illustrating the connecting ducts;

FIG. 2 is a sectional view of the first port for connection to the spray head;

FIG. 3 is a sectional view of the second port for connection to the distribution unit;

FIG. 4 is a sectional view of the connection of the first port to the spray head, illustrating the duct for the passage of mains water;

FIG. 5 is a sectional view of the spray head, illustrating the flow of the treated water;

FIG. 6 is a schematic perspective exploded view of the first port;

FIG. 7 is a schematic perspective view of the second port.

With reference to the figures, the assembly for the differential delivery of treated and mains water according to the invention comprises a flexible hose, generally designated by the reference numeral 1, which provides the separate conveyance of treated water and mains water; for this purpose, a first tube 2 for conveying mains water and a second tube 3 for conveying treated water are provided.

Advantageously, the second tube 3 is arranged inside the first tube 2, which accordingly has the appearance of a traditional flexible hose and is provided, at its ends, respectively with a first port 10 and a second port 11 which can be connected respectively to a spray head 12 and to a distribution unit 13.

In greater detail, the spray head 12 has a first delivery point 15 for delivering mains water, which in a per se known manner can have different types of jet.

A second delivery point 16 for treated water is arranged alongside the first delivery point 15.

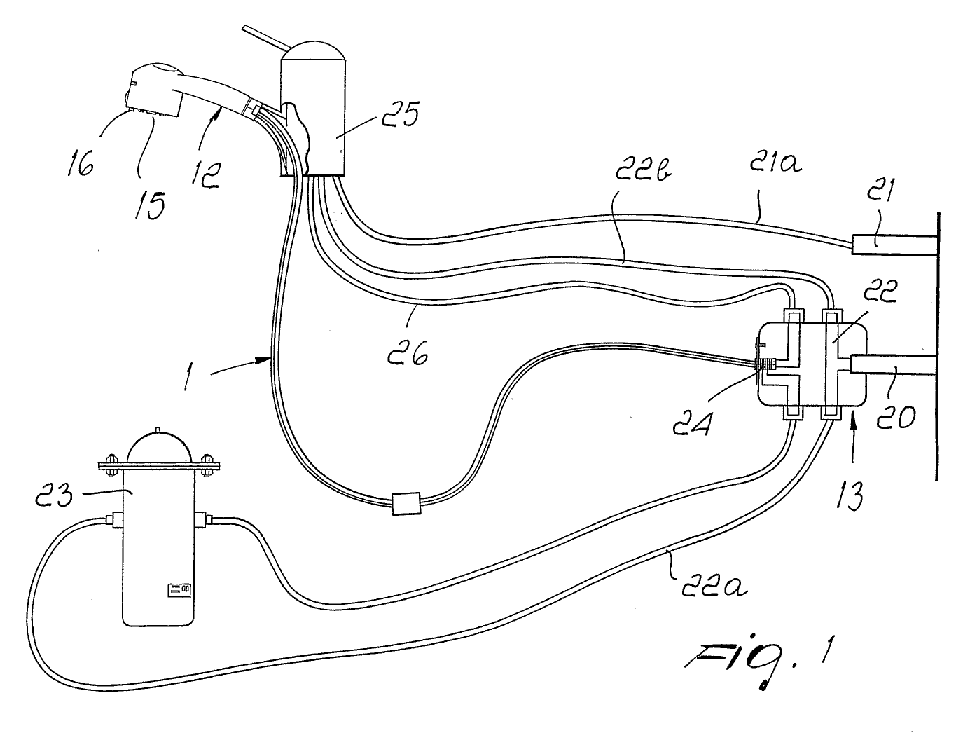

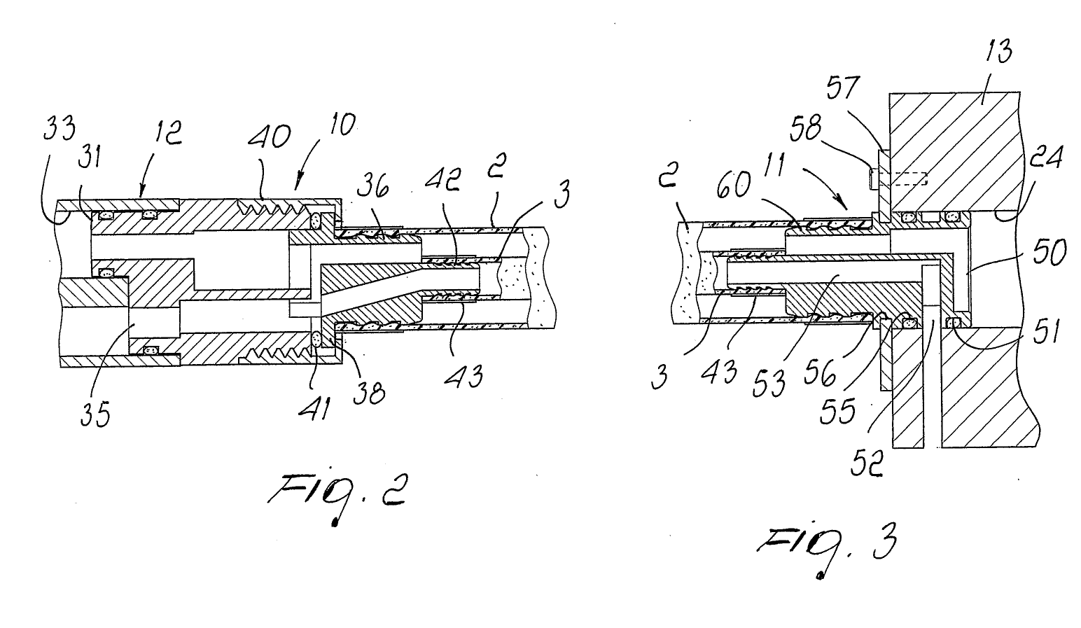

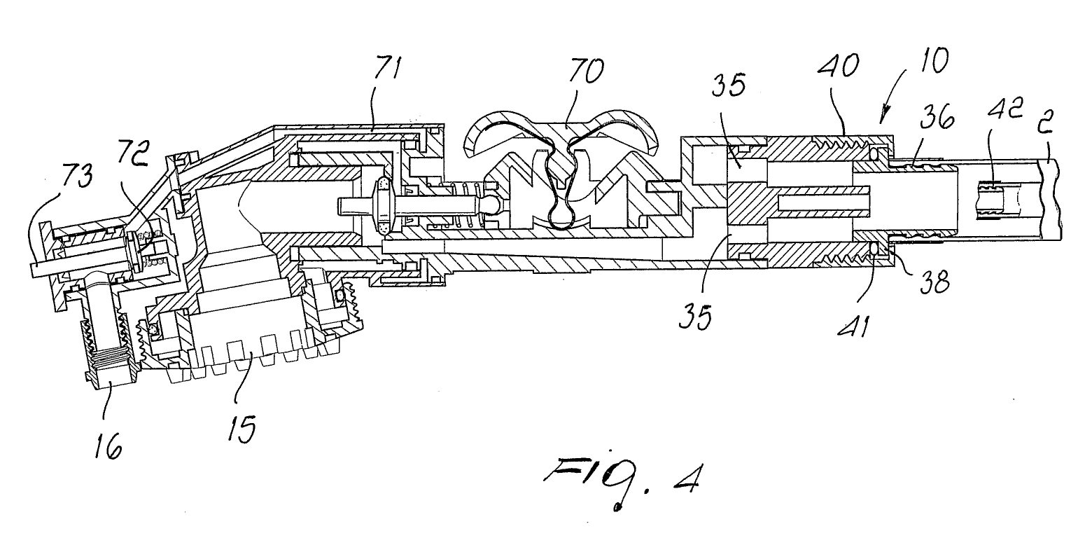

With reference to FIG. 1, the system is shown schematically: the reference numeral 20 designates the connection to the cold mains water and the reference numeral 21 designates the connection to the warm mains water.

The connection to the cold mains water advantageously has a branch 22 with an arm 22a, which leads to a unit 23 for treating treated water, the outlet whereof is connected radially to a seat 24 for delivering treated water, as described in greater detail hereinafter.

A mains water duct, designated by the reference numeral 22b, branches out from the branch 22 and is connected to the mixing valve 25, to which the hot mains water duct 21a is also connected.

A mixed mains water duct 26 exits from the mixing valve 25 and is connected axially to the seat 24, remaining separate with respect to the treated water that arrives from the treatment unit 23.

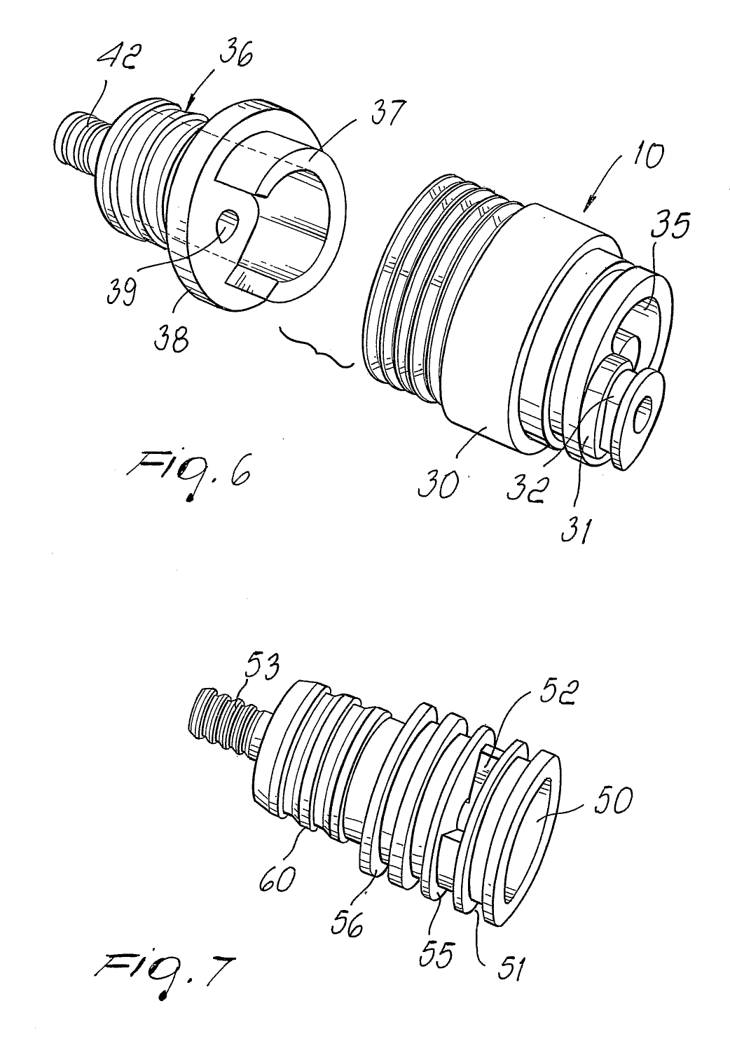

An important peculiarity of the invention consists in that the first port 10 is provided so as to rotate rigidly with the spray head, and for this purpose there is, as shown in FIG. 6, a terminal 30, having at the end for connection to the spray head, a protrusion 31, which is provided with a groove 32 for accommodating an O-ring, which is inserted in a seat 33 formed eccentrically on the spray head, so as to prevent the possibility of rotation of the port with respect to the spray head.

An opening 35 for the passage of the mixed mains water is arranged laterally adjacent to the protrusion 31.

At the other end of the terminal 30 there is a union 36, which is provided with axial fins 37, which enter the treated water delivery duct, which exits from the terminal 30 by way of the opening 35.

In this manner, the union 36 cannot rotate with respect to the terminal 30 and ensures the perfect connection of the channel 39 where the treated water flows.

Fastening is provided by means of a conventional ring 40, which acts on a flange 38 of the union 36, which in practice compresses a front gasket 41 between the terminal 30 and the union 36, achieving a perfect connection.

The union 36 is further provided with a central port 42, onto which the tube 3 is applied, said tube being retained by a fastening strap 43.

At the other end, the flexible hose 1 is provided with the second port 11, or female union, which has, at an axial end, an opening 50 for the outflow of the mains water, which is surrounded by a first groove 51, in which a seal is provided, while laterally adjacent to the first groove 51 there is a radial opening 52, which is connected to the channel for the treated water that arrives from a treated water port 53, which exits from the second port on the opposite side with respect to the opening 50.

A second groove 55 is laterally adjacent to the radial opening 52 for positioning an additional O-ring, and there is also a third groove 56, in which it is possible to arrange a plate 57 of the Seeger type or the like, which can be locked by means of a screw 58 or the like in order to retain in an axial direction the second port 11, allowing it to rotate freely in the seat of the distribution unit, designated by the reference numeral 24.

A union 60 is provided on the body of the second port 11 to connect the tube 2 for conveying mains water, which is connected, at the other end, to a similar connecting element provided on the first port.

With the arrangement described above, therefore, the flexible hose 1 rotates rigidly with the spray head, but it can rotate freely with respect to the distribution unit and in particular the second port can rotate freely with respect to the seat 24.

This fact is very important, since it prevents the formation of dangerous torsions in the flexible hose, which might lead to damage to the assembly.

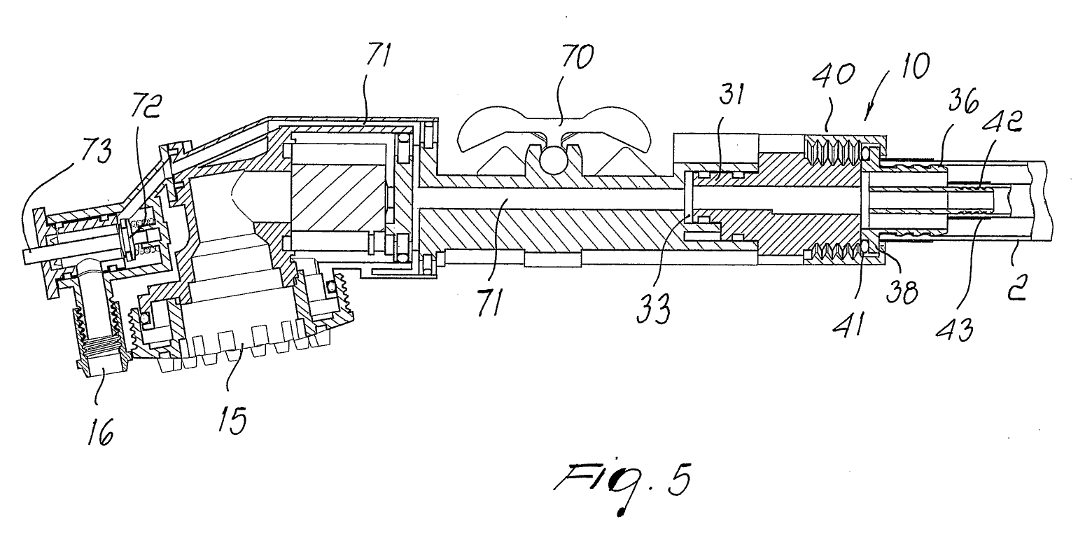

Inside the spray head 12, as shown in FIGS. 4 and 5, there are, in a per se known manner, the ducts for connection to the mains water delivery point, which can have different kinds of jet which can be controlled by means of a button 70 located on the spray head, and likewise there is the treated water supply duct 71, which is controlled advantageously by a flow control element 72, which is interposed on the duct for connection to the second delivery point 16 and can be actuated by means of a usual button 73, which allows to control delivery at will.

From what has been described above it is evident that the invention achieves the intended aim and objects, and in particular it is noted that an assembly for the differential delivery of treated and mains water is provided which allows to connect the flexible hose very quickly and above all by connecting the two different types of water without entailing any difficulty.

The invention thus conceived is susceptible of numerous modifications and variations, all of which are within the scope of the inventive concept.

All the details may further be replaced with other technically equivalent elements.

In practice, the materials used, as well as the contingent shapes and dimensions, may be any according to requirements.

The disclosures in Italian Patent Application no. MI2005A001252, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1. An assembly for the differential delivery of treated and mains water, comprising:
a flexible hose for the separate conveyance of treated water and mains water for connection between a spray head provided with at least two separate delivery points and a distribution unit for the separate supply of treated water and mains water, said flexible hose having, at its ends, respectively a first connection port, for connection to said spray head, and a second connection port, for connection to said distribution unit, said second port can be connected to said distribution unit so as to allow free rotation substantially about the axis of said second port.

2. The assembly according to claim 1, wherein said flexible hose comprises a first tube for conveying mains water and a second tube for conveying treated water, which is arranged inside said first tube.

3. The assembly according to claim 1, wherein said first port rotates rigidly with said spray head.

4. The assembly according to claim 1, wherein said first port comprises a body which defines, at the spray head connection end, a protrusion which is provided with a groove for accommodating an O-ring, which can be inserted hermetically in a seat defined in said spray head, an opening for the passage of mains water being provided laterally adjacent to said protrusion.

5. The assembly according to claim 1, further comprising union, which can be coupled to said terminal and is provided with fins which can be inserted in the delivery duct of said mains water, said union rotating rigidly with said terminal and forming a connection at the channel for the passage of the treated water.

6. The assembly according to claim 5, wherein said union is provided with a port for connection to said treated water passage tube.

7. The assembly according to claim 1, wherein said second connection port defines, at an axial end, an opening for the outflow of the mains water, which is surrounded by a first groove for accommodating a sealing O-ring, a radial opening being laterally adjacent to said first groove and being connected to the channel for the passage of the treated water that arrives from a treated water port, which exits from said second outlet on the opposite side with respect to said opening, a second groove for positioning an O-ring and a third groove for connection to a plate which can be fixed to the fixed structure and defines the seat for the free rotation of said port being also provided laterally adjacent to the radial opening for the passage of the treated water.

8. The assembly according to claim 1, further comprising a connection union for the mains water on said second connection port and a union for connection to the treated water supply duct.

9. The assembly according to claim 1, further comprising, within said spray head, a flow control element for controlling the delivery of said treated water, said flow control element being actuatable by a button, which protrudes on the outer surface of said spray head.

10. A flexible hose for differential delivery of treated and mains water, comprising.
a tube for conveying mains water inside which there is a treated water conveyance tube, a first connecting port for connection to a spray head and a second connecting port for connection to a distribution unit for supplying treated water and mains water being provided at the end of said flexible hose, characterized in that said first port is rigidly rotationally coupled to said spray head.

11. The flexible hose according to claim 10, wherein said second connecting port is connected to a distribution unit for supplying treated water and mains water with the possibility to rotate freely about the axis of the second port.
